(19) United States
(12) Patent Application Publication
(10) Pub. No.: US 2024/0323720 A1
(43) Pub. Date: Sep. 26, 2024

(54) Method for Supporting Edge Load Analytics at Application Data Analytics Enabler

(71) Applicant: LENOVO (SINGAPORE) PTE. LTD., SINGAPORE (SG)

(72) Inventors: Emmanouil Pateromichelakis, Viersen (DE); Dimitrios Karampatsis, Ruislp (GB)

(73) Assignee: LENOVO (SINGAPORE) PTE. LTD., SINGAPORE (SG)

(21) Appl. No.: 18/189,795

(22) Filed: Mar. 24, 2023

(30) Foreign Application Priority Data
Mar. 21, 2023 (GR) 20230100229

(51) Int. Cl. H04W 24/08; H04W 8/18

(52) U.S. Cl. CPC H04W 24/08; H04W 8/18

(57) ABSTRACT

The invention provides a functionality for providing edge load analytics at an edge analytics producer as well as functionality for utilizing this edge load analytics for optimizing edge service performance. An edge analytics producer is configured to collect data and to perform edge load analytics considering data producers from different domains, to allow for edge analytics enablement. Further, based on the derived edge load analytics by the edge analytics producer, an analytics consumer is configured to generate a trigger event that indicates a predicted overload and a specific action to be performed.

### RELATED APPLICATION

This application claims priority to Greece application Ser. No. 20230100229 filed Mar. 21, 2023, entitled “Method for Supporting Edge Load Analytics at Application Data Analytics Enabler,” the disclosure of which is incorporated by reference herein in its entirety.

### BACKGROUND

In 3GPP, data analytics services are provided by the network data analytics function (NWDAF) and aim to support network data analytics services in a 5G Core (5GC) network. Such analytics can collect data from other network functions (NF), or analytics functions (AF) or from operation, administration and maintenance (OAM) and can be exposed to a third party and/or AF to provide statistics and predictions related to a slice load level, observed service experience, NF load, network performance, user equipment (UE) related analytics such as mobility or communication, user data congestion, quality of service (QOS) sustainability, data network (DN) performance, etc.

In vertical scenarios, further data analysis on top of the 5G system (5GS) may be needed, to provide a useful output to an application specific layer for an end-to-end application service, including application server related and application session related statistics and/or prediction. The statistics and/or predictions may be supported and/or enhanced by collecting data from different domains based on consumer needs. Such collection can be from the 5GS via northbound application programming interfaces (APIs) such as NWDAF or management domain analytics service (MDAS), or from an application specific layer in a data network (DN). For example, data may be related to collecting HD maps, camera feeds, sensor data, data related to edge and/or cloud resources, data related to an application server status like for example a load of an edge application server (EAS) or a load of an application server (AS), or data from a UE side comprising UE routes and/or trajectories. Hence, the application data collection may be provided by different sources comprising for example a vertical-specific server, an application of the UE, an EAS, a third party server, or a service enabler architecture layer (SEAL). Therefore, it needs to be identified how these data can be collected to allow for statistics and/or predictions by an analytics enablement layer.

Application Data Analytics Enabler Server (ADAES) is a new enablement service, which may be part of SEAL, and discusses new potential application data analytics services related to obtaining statistics and/or predictions to optimize an application service operation by notifying the application specific layer, and potentially the 5GS, about expected and/or predicted changes in application service parameters such as for example QoS parameters considering both on-network and off-network deployments.

Edge deployments are vitally important for applications that require performance levels that cannot be met by existing cloud deployments. Edge data analytics may relate to statistics and/or predictions on computational resources and expected and/or predicted load of the platform, which hosts the edge applications. It may be necessary to expose these edge data analytics as a service to an EAS. The edge applications can be either edge native applications or edge enhanced applications at a centralized cloud. Particularly, for edge native applications which need to be light designed and highly portable, the use of edge analytics at the edge platform can help improving the application service operation.

The support for edge analytics that may be related to the edge performance, to failures and a service availability at an enablement layer would be useful for the edge applications to allow for dynamically deciding to scale-in, to scale-out, to migrate from the edge to the cloud in heavy load situations, or to migrate from the cloud to the edge to improve the quality of experience for the end user.

Hence, it would be desirable to provide edge analytics enablement related to edge performance, failure, load, service availability etc. by collecting data from data producers of different domains and performing edge load analytics based on these collected data. In a further step, it would be desirable to utilize these edge load analytics for optimizing an edge service performance.

These problems have so far not been addressed in 3GPP. Prior art solutions provide mechanisms for application layer analytics that may be related to application servers or sessions regarding performance. However, such prior art solutions do not discuss an edge load type of analytics subscription and providing the analytics per data network name (DNN), per data network access identifier (DNAI), per edge data network (EDN) or per edge enabler server (EES), etc.

Likewise, prior art does not address collecting certain types of data from some sources such as N6 endpoint, multi-access edge computing (MEC) platform service such as a radio network information service (RNIS), operation administration and maintenance (OAM) function for computational load, etc. As prior art does not disclose providing the analytics per DNN, per DNAI, per EDN or per EES, etc., prior art is also silent about providing output data per DNN, per DNAI, per EDN or EES, etc. Further, the issue of utilizing an analytics output for recommending a certain action for edge nodes and triggering of an overload have not been discussed so far.

### SUMMARY

In an aspect, the present invention provides a computer-implemented method for edge load analytics at an ADAES. In another aspect, the present invention is directed to an apparatus such as an ADAES that is configured to perform this computer-implemented method.

Edge load analytics provide an insight into the operation and performance of an EDN. In particular, edge load analytics may provide statistics or predictions of parameters that are related to an EAS or EES load for one or more EAS or EES, respectively, as well as to edge platform load parameters that may include an aggregated load per EDN or per DNAI due to edge support services and for example load levels of edge computational resources.

Thus, a first aspect of the present invention refers to an apparatus that comprises one or more processors configured to execute computer-readable instructions for supporting edge load analytics. These instructions cause the one or more processors to receive, from an analytics consumer, a subscription request for load analytics for an edge node. Hereby, the subscription request at least indicates an analytics event identifier. Further, the apparatus is configured to determine a mapping of the analytics event identifier to at least one of a list of data collection event identifiers and a list of data producer identifiers. Subsequently, the computer-readable instructions executed by the one or more processors of the apparatus cause the one or more processor to transmit a data collection subscription request to the data producers identified by the list of data producer identifiers, wherein the data collection subscription request comprises at least one of the analytics event identifier and the respective data collection event identifier. In a next step, the apparatus is configured to receive data from the data producers, the received data hereby corresponding to the analytics event identifier or to the respective data collection event identifier. The computer-readable instructions executed by the one or more processor then cause the one or more processor to derive edge load analytics for the edge node from the received data corresponding to the subscription request. The edge load analytics may indicate at least one of statistics and a prediction of the load for the edge node. Finally, the apparatus according to this first aspect of the present invention is configured to transmit the derived edge load analytics to the analytics consumer.

Such derived edge load analytics may improve edge support services by allowing pro-active edge service operation changes to deal with possible edge overload scenarios. For example, these analytics may trigger EAS migration to a different EDN or central data network, or alternatively a pro-active EAS reselection for a target UE or a group of UEs.

Hence, a second embodiment of the present invention relates to an apparatus that comprises one or more processors configured to execute computer-readable instructions for utilizing edge load analytics for optimizing edge service performance. These instructions cause the one or more processors to send a subscription request for edge load analytics to an edge analytics producer and subsequently to receive derived edge load analytics from this edge analytics producer. Subsequently, the computer-readable instructions of the apparatus according to the second embodiment of the present invention cause the one or more processor to generate a trigger event that indicates a predicted overload and an action based on the derived edge load analytics.

As mentioned above, in a further aspect, the present invention also refers to a computer-implemented method for providing edge load analytics. In a first step of this method, a subscription request for load analytics for an edge node is received by an ADAES. Hereby, the subscription request indicates an analytics event identifier. Further, the method comprises the step of determining, by the ADAES, a mapping of the analytics event identifier to at least one of a list of data collection event identifiers and a list of data producer identifiers. Subsequently, the method includes the step of transmitting, by the ADAES, a data collection subscription request to the data producers identified by the list of data producer identifiers. The data collection subscription request comprises at least one of the analytics event identifier and the respective data collection event identifier. Moreover, the method according to the further aspect of the present invention includes receiving data from the data producers at the ADAES. Hereby, the received data correspond to at least one of the analytics event identifier and the respective data collection event identifier. A further method step then comprises deriving edge load analytics for the edge node from the received data corresponding to the subscription request, where the edge load analytics indicate at least one of the statistics and a prediction of the load for the edge node. Subsequently, the method comprises transmitting the derived edge load analytics to the analytics consumer. Finally, according to another aspect of the method according to the present invention, a trigger event that indicates a predicted overload and an action may be generated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

FIG. 1 is an exemplary flow diagram of a procedure for supporting edge load analytics according to a first embodiment of the present invention.

FIG. 2 is an exemplary flow diagram of a procedure for utilizing edge load analytics for triggering an action according to a second embodiment of the present invention.

FIG. 3 illustrates an example of an apparatus that is configured to perform the procedure according to both the first and the second embodiment of the present invention.

### DETAILED DESCRIPTION

Reference will now be made in detail to the exemplary embodiments, examples of which are illustrated in the accompanying drawings in which like reference numerals refer to like elements unless specified otherwise.

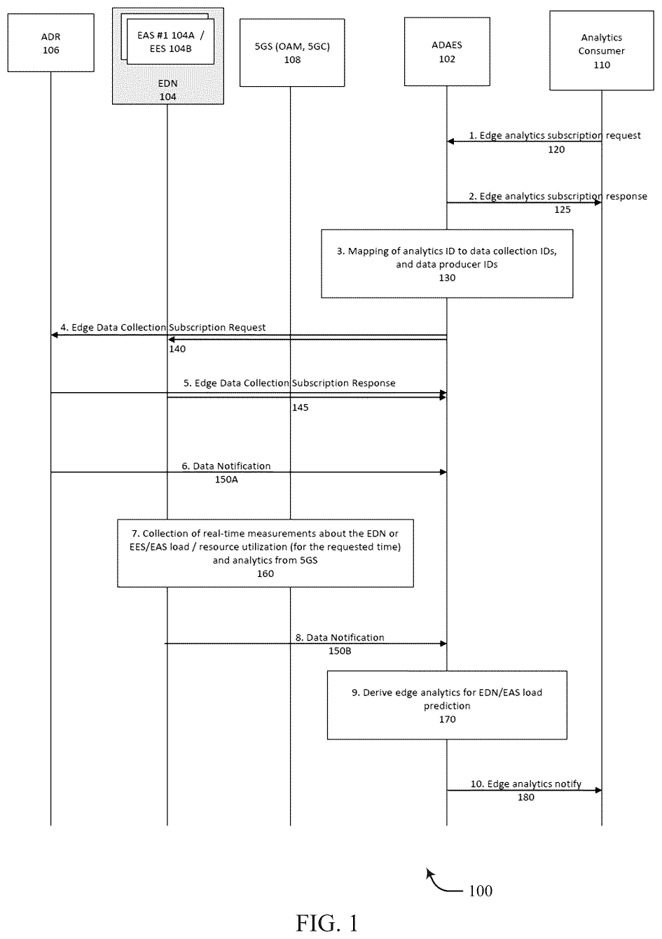

FIG. 1 illustrates a procedure 100 for supporting edge load analytics at an edge analytics producer 102 according to a first embodiment of the present invention. In particular, FIG. 1 shows an ADAES as an example for an edge analytics producer 102.

In the first embodiment of the present invention illustrated in FIG. 1, data for performing edge load analytics may be collected from the EDN 104 and/or from one or more of a plurality of EAS 104A and EES 104B being comprised in the EDN 104. Alternatively or additionally, data for performing edge load analytics may be collected from an analytical data repository (ADR) 106. ADR 106 is an entity that stores historical data and/or analytics, i.e., data and/or analytics related to a past time period that has been obtained by e.g. an ADAES such as for example ADAES 102. After obtaining such data and/or analytics, an ADAES such as for example ADAES 102 may store historical data and/or analytics in an ADR 106.

The ADR 106 may be an application layer-analytics and data repository function (A-ADRF) as defined in TS 23.436, an analytics and data repository function (ADRF) as defined in TS 23.288, a common application programming interface (API) framework (CAPIF) core function as defined in TS 23.222, or any other repository that stores offline data in an edge or in a cloud platform.

ADAES 102 may readily fulfill the preconditions of having discovered the respective application programming interfaces to access a plurality of edge services of an EDN 104 and of having subscribed to OAM of a 5GS 108 and to an NWDAF for respectively receiving management and data network (DN) performance analytics.

FIG. 1 further shows an analytics consumer 110 of the ADAES 102 analytics service. Analytics consumer 110 may transmit a subscription request 120 for load analytics for an edge node to the ADAES 102. Hereby, an edge node can be at least one of an EDN 104, an EAS 104A, an EES 104B, etc.

The subscription request 120 may comprise an information element indicating an analytics event identifier and may comprise further information elements. These further information elements include at least one of an analytics consumer identifier, an analytics filter information, an analytics type, a destination EAS identifier, a destination EES identifier, a DNN, a DNAI, an area of interest and a time validity.

An analytics event identifier may be an identifier of an analytics event. An example for such an event may be an edge performance analytics. An analytics consumer identifier may be an identifier of an analytics consumer 110 such as a vertical application layer (VAL) server, an EAS, etc. An analytics filter information comprises filter information for an analytics event, while an analytics type may describe whether an analytics event may concern a prediction or a statistics. A destination EAS identifier may identify a destination EAS 104A associated with the subscription request 120 and a destination EES identifier may identify a destination EES 104B that is associated with the subscription request 120. A DNN element may describe DNN information associated with the subscription request 120 and a DNAI element may indicate DNAI information associated with the subscription request 120. A preferred confidence level may indicate a level of accuracy of an analytics service that may be achieved in the case of a prediction. An area of interest may describe a geographical area or a service area associated with the subscription request 120. A time validity information element may describe a time validity of the subscription request 120.

Further, as can be seen in FIG. 1, ADAES 102 may transmit a subscription response 125 as an acknowledgement to the analytics consumer 110.

ADAES 102 may further determine a mapping 130 of an analytics event identifier comprised in the subscription request 120 to at least one of a list of data collection event identifiers and a list of data producer identifiers. Alternatively, such a mapping 130 may already be preconfigured by OAM. The data producers may be at least one of EAS 104A, EES 104B onboarded to EDN 104, ADR 106, components of 5GS 108 such as OAM and 5GC and MEC platform services not shown in FIG. 1.

As a next step, ADAES 102 may transmit a data collection subscription request 140 to the data producers identified by the list of data producer identifiers. The data collection subscription request 140 may comprise at least one of an analytics event identifier and a respective data collection event identifier.

In addition, the data collection subscription request 140 may comprise at least one of an ADAES identifier, data collection requirements, a list of data producer identifiers, a destination EAS identifier, a destination EES identifier, a DNN, a DNAI, an area of interest and a time validity.

Hereby, the ADAES identifier may be an identifier of the ADAES 102, the destination EAS identifier may identify a destination EAS associated with the subscription request 120, the destination EES identifier may identify a destination EES associated with the subscription request 120, the DNN element may indicate DNN information associated with the subscription request 120, and the DNAI element may indicate DNAI information associated with the subscription request 120. Further, the area of interest may indicate at least one geographical area and a service area associated with the subscription request 120, while the time validity information element may describe a time validity indication of the subscription request 120.

The above-mentioned list of data producer identifiers may need to be included in the data collection subscription request 140, when the data collection subscription request 140 is performed via an application layer data collection and coordination function (A-DCCF).

Moreover, the data collection requirements included in the data collection subscription request 140 may comprise at least one of a data format, a reporting frequency, an abstraction level of the data and an accuracy level of the data. For example, a reporting frequency may indicate that collected data may be provided once or periodically based on a threshold like for example a load of more than a certain percentage.

Subsequently, in the procedure 100 for supporting edge load analytics according to the first embodiment of the present invention, the data producers may transmit a data collection subscription response 145 to the ADAES 102. This data collection subscription response 145 that is received at the ADAES 102 may be a positive or a negative acknowledgement of the data collection subscription request 140.

Further, according to the first embodiment of the present invention as illustrated in FIG. 1, the ADAES 102 may receive data from the data producers. These received data may correspond to the analytics event identifier or to the respective data collection event identifier and may be received at the ADAES 102 as a data notification message. This data notification message may include at least one of a data notification message 150A that may be received by the ADAES 102 from an ADR 106 and a data notification message 150B received from a data producer such as at least one of an EDN 104, an EAS 104A and an EES 104B.

The data received by the ADAES 102 may include offline data from the ADR 106. As mentioned before, the ADR 106 may be an A-ADRF, an ADRF, a CAPIF core function, or any other repository that stores offline data in an edge or in a cloud platform.

The offline data received from the ADR 106 may comprise statistics and may include at least one of historical and non-real-time measurements and data and analytics produced offline based on the historical measurements. Such offline data may be kept in a database or repository as for example ADR 106 in certain implementations.

The offline data received at the ADAES 102 from the ADR 106 may comprise at least one of load statistics in terms of numbers of EAS 104A or EES 104B connections for a given area or time window, statistics regarding an average edge computational resource usage, a resource ratio based on a total resource availability of an EDN 104, an EDN 104 overload indication, a high load indication event, and a probability of EAS 104A and EES 104B unavailability due to high load.

The data notification message 150A received by the ADAES 102 from the ADR 106 may comprise at least one of a data collection event identifier, a data producer identifier, a destination EAS identifier, a destination EES identifier, a DNN, a DNAI, an analytics identifier, a data type and a data output.

Apart from the data type and the data output information elements, all other mentioned information elements of the data notification message 150A have already been described in detail above when discussing the subscription request referring to the edge analytics transmitted by analytics consumer 110 and the data collection subscription request transmitted by the ADAES 102. Hence, a description of these information elements will not be repeated here.

The data type of the data received from the ADR 106 and included in data notification message 150A my comprise a type of the reported data samples, which may be at least one of network data, application data, edge data, and different granularities and abstraction of the data.

The data output of the data received from the ADR 106 and included in data notification message 150A may comprise the reported data that may be offline or historical data about requested parameters based on the subscription. The data output may be data per EDN 104, per DNAI, or per EAS 104A or per EES 104B and may comprise load statistics and edge computational resource utilization statistics for at least one of a given time and an area of interest.

Alternatively or additionally to the offline data, the data received at the ADAES 102 may also comprise real-time data collected from the data producers. The data producers may start collecting 160 real-time measurements about at least one of a load and a resource utilization of the EDN 104, the EES 104A, and the EAS 104B for a requested time as well as analytics from 5GS 108.

More in detail, the real-time collected data at the data producers may comprise at least one of load statistics in terms of numbers of EAS 104A or EES 104B connections for a given area or time window, statistics regarding an average edge computational resource usage, a resource ratio based on a total resource availability of an EDN 104, an EDN 104 overload indication, a high load indication event, and a probability of EAS 104A and EES 104B unavailability due to high load.

The real-time collected data from the data producers is received at the ADAES 102 as a data notification message 150B. The content of this data notification message 150B may comprise the same information elements that have been described before for the data notification message 150A that is received from ADR 106 at the ADAES 102. Accordingly, the content of data notification message 150B is regarded as being similar to the content of data notification message 150A. Thus, a detailed description thereof will be omitted here.

Further, it should be noted that data notification message 150A and data notification message 150B are not necessarily meant to be transmitted sequentially. Instead, these two data notification messages 150A and 150B may also be transmitted in parallel or in a different order.

The data producers that may provide the real-time collected data may comprise at least an EAS 104A, an EES 104B, an N6 endpoint, an OAM function, a service enabler architecture layer data delivery server (SEALDD), at least one of a 5GC and an NWDAF, an MDAS, and an MEC such as an RNIS.

Hereby, the EAS 104A may provide at least one of computational resource load per EAS 104A and a number of connections of the EAS 104A, while the EES 104B may provide at least one of computational resource load per EES 104B and a number of connections of the EES 104B.

Moreover, the N6 endpoint may provide an N6 load and the OAM function may provide at least one of a computational resource load per EAS 104A and a number of connections of the EAS 104A and at least one of a computational resource load per EES 104B and a number of connections of the EES 104B. Further, the SEALDD may provide N6 load measurements and a SEALDD computational resource load, and the at least one 5GC and NWDAF may provide data network performance analytics. In addition, at least one of OAM and MDAS may provide user plane function (UPF) load analytics per DNAI and the MEC platform service such as an RNIS may provide per cell average radio conditions and at least one of a load and a resource utilization for all cells within EDN 104.

Turning back to the overall method according to the first embodiment of the present invention as illustrated in FIG. 1, the data received at the ADAES 102 that corresponds to the subscription request 120 may be used to derive 170 edge load analytics for the edge node. The edge load analytics derived in this way may indicate at least one of statistics and a prediction of the load for the edge node. As mentioned above, the edge node may be at least one of an EDN 104, an EAS 104A, an EES 104B, etc.

More in detail, based on the analytics identifier and a type of request, the ADEAS 102 may derive edge analytics on at least one of EDN 104 load, DNAI load and per EAS 104A and per EES 104B load. The ADAES 102 may derive these analytics based on at least one of the performance analytics received per data network and load analytics per DNAI or UPF. In addition, when deriving these analytics, the ADAES 102 may also consider measurements on at least one of a computational and a radio access network (RAN) resource load and a number of connections for the EAS 104A and EES 104B that are active at the EDN 104.

Finally, according to the procedure 100 shown in FIG. 1 of the present invention, the ADAES 102 may transmit the derived edge load analytics 170 to the analytics consumer 110. As mentioned before, these transmitted edge load analytics 170 may indicate a prediction of the EDN 104 load considering inputs from both 5GS 108 as well as from edge platform services.

Importantly, these predictions may also be in the form of a recommendation for triggering an EAS 104A relocation to a different platform due to an expected high load on edge resources.

ADAES 102 may transmit the derived edge load analytics 170 to the analytics consumer 110 in the form of an edge analytics notification 180. This edge analytics notification 180 may comprise at least one of an analytics identifier, an analytics type, an analytics output and a confidence level. While the analytics identifier may be the identifier of the analytics event, the analytics type may indicate the type of analytics based on the analytics event. Such an analytics type may include at least one of offline or online analytics, machine learning enabled analytics, statistics and predictive analytics. The analytics output may indicate at least one of the predictive and statistical parameter, which may be statistics or a prediction related to an edge performance or load for at least one of an edge platform and an EAS 104A and EES 104B for at least one of a given area and time and based on the event type. Finally, the achieved confidence level may be provided in the case of predictive analytics.

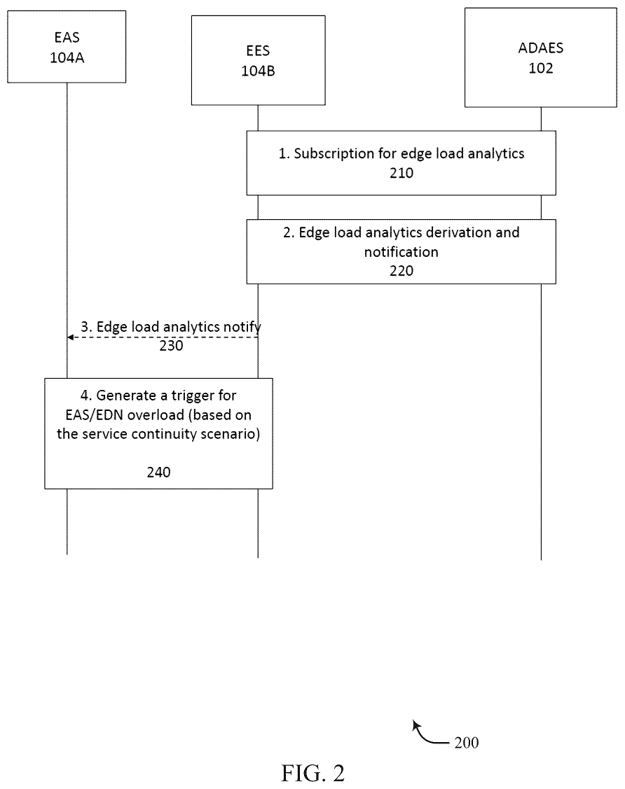

FIG. 2 illustrates a second embodiment of the present invention. This second embodiment of the present invention is directed to a procedure 200 for utilizing edge load analytics for optimizing edge service performance.

The first embodiment according to the present invention described a method 100 for edge load analytics service to provide an insight into the operations and the performance of an EDN 104 and in particular into at least one or more statistics and predictions on parameters related to a load of an EAS 104A or an EES 104B for at least one or more of an EAS 104A and an EES 104B.

Such analytics may improve edge support services by allowing edge service operations to deal proactively with possible edge overload scenarios.

Some edge support services may benefit from using ADAES 102 analytics related to the EDN 104 or to a service load of at least one of the EAS 104A and the EES 104B. In standard TS 23.558, one of the conditions for service continuity is the overload situations of at least one of EAS 104A and EDN. Hence, edge load analytics including at least one of predictions and statistics may help pro-actively trigger actions to prevent loss of service due to an expected overload.

As can be seen in FIG. 2, it is a precondition of the second embodiment of the present invention that an edge analytics producer 102 such as for example an ADAES is available at the EDN 104 and that this edge analytics producer 102 is accessible to an EES 104B.

In a first step of the method 200 according to the second embodiment of the present invention, an apparatus such as for example EES 104B as illustrated in FIG. 2 may send a subscription request 210 for edge load analytics to the edge analytics producer 102.

Hereby, as mentioned above, the edge analytics producer 102 may be an ADEAS, whereas the apparatus 104B may comprise at least one of an EES, an EAS and an analytics consumer.

The subscription request 210 may further correspond to the subscription request 120 of the first embodiment of the present invention.

In a next step of the method according to the second embodiment of the present invention, the apparatus such as for example EES 104B may receive derived edge load analytics 220 from the edge analytics producer 102. The derived edge load analytics may be derived by the edge analytics producer 102 according to the first embodiment of the present invention.

Optionally, the EES 104B may also provide the received edge load analytics to EAS 104A.

Finally, based on the derived edge load analytics in step 220, the apparatus may generate a trigger event 240 indicating a predicted or expected overload for at least one of an EDN 104, an EAS 104A and an EES 104B together with an action.

Such a possible action may comprise an application context relocation (ACR) including at least one of a migration of an edge node such as an EAS 104A and an EES 104B to a different EDN 104 and a pro-active EAS reselection for a target user equipment (UE) or for a group of UEs.

Depending on the service continuity scenario according to standard TS 23.558, this last step of the method 200 according to the second embodiment of the present invention is either performed at the EAS 104A or at the EES 104B. In this context, it is pointed out that the entity among EAS 104A and EES 104B that indicates an EAS or EES expected overload based on the received load analytics may be responsible for triggering the respective action.

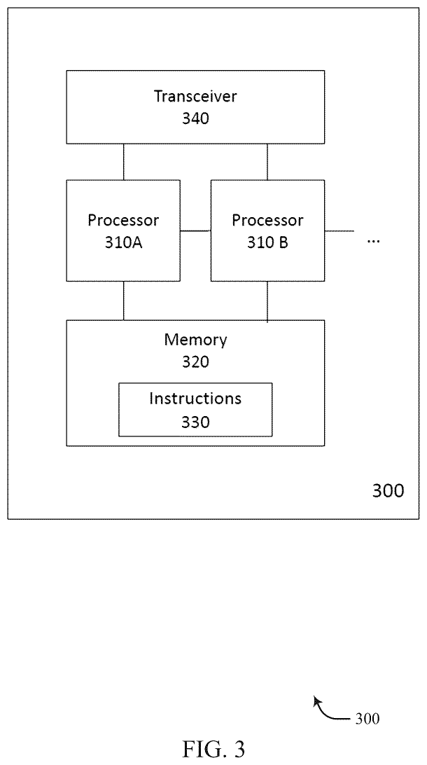

FIG. 3 depicts an apparatus 300 that may exemplify the ADAES 102 as well as the analytics consumer 110.

Apparatus 300 may comprise a memory 320, one or more processor 310A, 310B, etc. and a transceiver 340. Memory 320 may be a volatile memory such as for example DRAM or SRAM or a non-volatile memory such as for example SDD or HDD storage. Memory 320 stores computer-readable instructions 330 that the one or more processors 310A, 310B, etc. are configured to execute. When executing these computer-readable instructions 330, the one or more processors 310A, 310B, etc. may implement the method of the first and of the second embodiment as described above with respect to FIGS. 1 and 2, respectively.

The embodiments presented herein are not to be understood as restricted to only the described specific combination of features performed by hardware and/or software entities. In particular, other possible embodiments may comprise any combination of features from described embodiments. Moreover, features described in the context of a certain embodiment may also be comprised in other embodiments without being explicitly presented as such. Embodiments may comprise more or less features than described. Further, software and hardware entities may perform more or less features than described in certain embodiments. A software or hardware entity may also perform features that are described in the context of other software or hardware entities. In addition, steps described in a certain order in the context of a method may be performed in any other reasonable order. It is to be understood that the present description encompasses all embodiments that arise from these alternative combinations of features and entities.

While the invention has been described with respect to the physical embodiments constructed in accordance therewith, it will be apparent to those skilled in the art that various modifications, variations and improvements of the present invention may be made in light of the above teachings and within the purview of the appended claims without departing from the spirit and intended scope of the disclosure. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

1. An apparatus comprising one or more processors configured to execute computer-readable instructions for supporting edge load analytics, the instructions causing the one or more processors to:
receive, from an analytics consumer, a subscription request for load analytics for an edge node, the subscription request indicating an analytics event identifier;
determine a mapping of the analytics event identifier to at least one of a list of data collection event identifiers and a list of data producer identifiers;
transmit a data collection subscription request to the data producers identified by the list of data producer identifiers, wherein the data collection subscription request comprises at least one of the analytics event identifier and the respective data collection event identifier;
receive data from the data producers, the received data corresponding to the analytics event identifier or the respective data collection event identifier;
derive edge load analytics for the edge node from the received data corresponding to the subscription request, wherein the edge load analytics indicate at least one of statistics and a prediction of the load for the edge node; and
transmit the derived edge load analytics to the analytics consumer.

2. The apparatus of claim 1, wherein the edge node is an edge data network (EDN), an edge enabler server (EES), or an edge application server (EAS).

3. The apparatus of claim 1, wherein the subscription request further comprises at least one of:
an analytics consumer identifier, a filter information for an analytics event, an analytics type of the analytics event, a destination EAS identifier identifying a destination EAS associated with the subscription request, a destination EES identifier identifying a destination EES associated with the subscription request, data network name (DNN) information associated with the subscription request, data network access identifier (DNAI) information associated with the subscription request, a preferred confidence level for a prediction, a geographical area associated with the subscription request, a service area associated with the subscription request, and a time validity indication of the subscription request.

4. The apparatus of claim 3, wherein the analytics type of the analytics event indicates whether the analytics event concerns a prediction or a statistics.

5. The apparatus of claim 1, the instructions further causing the one or more processors to:
transmit a subscription response as an acknowledgement to the analytics consumer.

6. The apparatus of claim 1, wherein the mapping is preconfigured by an operation administration and maintenance (OAM) function.

7. The apparatus of claim 1, wherein the data collection subscription request further comprises at least one of: an apparatus server identifier, data collection requirements, the list of data producer identifiers, a destination EAS identifier identifying a destination EAS associated with the subscription request, a destination EES identifier identifying a destination EES associated with the subscription request, a data network name (DNN) information associated with the subscription request, a data network access identifier (DNAI) information associated with the subscription request, a preferred confidence level for prediction, a geographical area associated with the subscription request, a service area associated with the subscription request, and a time validity indication of the subscription request.

8. The apparatus of claim 7, wherein the data collection requirements include at least one of: a data format, a reporting frequency, an abstraction level of the data, and an accuracy level of the data.

9. The apparatus of claim 1, the instructions further causing the one or more processors further to:
receive a data collection subscription response from the data producers, the data collection subscription response being a positive or negative acknowledgement.

10. The apparatus of claim 1, the instructions further causing the one or more processors further to:
receive offline data from an analytical data repository.

11. The apparatus of claim 10, wherein the received data comprises at least one of: load statistics in terms of numbers of EAS or EES connections for a given area or time window, statistics regarding an average edge computational resource usage, a resource ratio based on a total resource availability of an EDN, an EDN overload indication, a high load indication event, and a probability of EAS and EES unavailability due to high load,

12. The apparatus of claim 10, wherein the received data concerns a given time or area of interest.

13. The apparatus of claim 1, the instructions further causing the one or more processors to:
receive real-time collected data from the data producers.

14. The apparatus of claim 13, wherein the real-time collected data comprises at least one of: load statistics in terms of numbers of EAS or EES connections for a given area or time window, statistics regarding an average edge computational resource usage, a resource ratio based on a total resource availability of an EDN, an EDN overload indication, a high load indication event, and a probability of EAS and EES unavailability due to high load.

15. The apparatus of claim 1, wherein the data producers comprise at least one of the following:
an edge application server (EAS) providing at least one of computational resource load per EAS and a number of connections of the EAS;
an edge enabler server (EES) providing at least one of computational resource load per EES and a number of connections of the EES;
an N6 endpoint providing an N6 load;
an OAM function providing at least one of computational resource load per EAS and a number of connections of the EAS;
an OAM function providing at least one of computational resource load per EES and a number of connections of the EES;
a service enabler architecture layer data delivery server (SEALDD) providing N6 load measurements and a SEALDD computational resource load;
at least one of a 5G core (5GC) and a network data analytics function (NWDAF) providing data network performance analytics;
a management domain analytics service (MDAS) providing load analytics per data network access identifier (DNAI); and
a multi-access edge computing (MEC) platform service such as a radio network information service (RNIS) providing per cell average radio conditions and a load for all cells within an edge data network (EDN).

16. An apparatus comprising one or more processors configured to execute computer-readable instructions for utilizing edge load analytics for optimizing edge service performance, the instructions causing the one or more processors to:
send a subscription request for edge load analytics to an edge analytics producer;
receive derived edge load analytics from the edge analytics producer; and
generate a trigger event indicating a predicted overload and an action based on the derived edge load analytics.

17. The apparatus of claim 16, wherein the action comprises at least one of a migration of an edge node to a different edge data network (EDN) and a pro-active edge application server (EAS) reselection for a target user equipment (UE) or a group of UEs.

18. The apparatus of claim 16, wherein the apparatus comprises at least one of an edge enabler server (EES), an edge application server (EAS), or an analytics consumer.

19. A computer-implemented method for providing edge load analytics, the computer-implemented method comprising:
receiving a subscription request for load analytics for an edge node by an application data analytics enablement server (ADAES), the subscription request indicating an analytics event identifier;
determining, by the ADAES, a mapping of the analytics event identifier to at least one of a list of data collection event identifiers and a list of data producer identifiers;
transmitting, by the ADAES, a data collection subscription request to the data producers identified by the list of data producer identifiers, wherein the data collection subscription request comprises at least one of the analytics event identifier and the respective data collection event identifier;
receiving data, by the ADAES, from the data producers, the received data corresponding to the at least one of the analytics event identifier and the respective data collection event identifier;
deriving edge load analytics for the edge node from the received data corresponding to the subscription request, wherein the edge load analytics indicate at least one of statistics and a prediction of the load for the edge node; and
transmitting the derived edge load analytics to the analytics consumer.

20. The computer-implemented method of claim 19, further comprising:
generating a trigger event indicating a predicted overload and an action, wherein the action comprises at least one of:
migration of the edge node to a different edge data network (EDN), and
a pro-active edge application server (EAS) reselection for a target user equipment (UE) or a group of UEs.
